(19) United States
(12) Patent Application Publication
(10) Pub. No.: US 2013/0097412 A1
(43) Pub. Date: Apr. 18, 2013

(54) Performing A Boot Sequence In A Multi-Processor System

(71) Applicants: Shiva R. Dasari, Austin, TX (US); Raghuswamyreddy Gundam, Austin, TX (US); Newton P. Liu, Austin, TX (US); Terence Rodrigues, Austin, TX (US); Mehul M. Shah, Austin, TX (US); Robert K. Sloan, Pflugerville, TX (US); Wingcheung Tam, Austin, TX (US); Mark W. Wenning, Cedar Park, TX (US)

(72) Inventors: Shiva R. Dasari, Austin, TX (US); Raghuswamyreddy Gundam, Austin, TX (US); Newton P. Liu, Austin, TX (US); Terence Rodrigues, Austin, TX (US); Mehul M. Shah, Austin, TX (US); Robert K. Sloan, Pflugerville, TX (US); Wingcheung Tam, Austin, TX (US); Mark W. Wenning, Cedar Park, TX (US)

(73) Assignee: INTERNATIONAL BUSINESS MACHINES CORPORATION, ARMONK, NY (US)

(21) Appl. No.: 13/275,019

(22) Filed: Oct. 17, 2011

(51) Int. Cl. G06F 9/445

(52) U.S. Cl. 713/2

(57) ABSTRACT

Methods, apparatuses, and computer program products for performing a boot sequence in a multi-processor system are provided. Embodiments include: in response to detecting initiation of a boot sequence of the multi-processor system, initializing, by a bootstrap processor (BSP), BSP memory associated with the BSP and initializing, by an application processor, memory associated with the application processor; determining, by the BSP, whether the initialization of the BSP memory is completed; and if the initialization of the BSP memory is completed, loading, by the BSP, an operating system on the BSP memory regardless of whether the application processor has completed initialization of the memory associated with the application processor.

### BACKGROUND OF THE INVENTION

1. Field of the Invention

The field of the invention is data processing, or, more specifically, methods, apparatuses, and computer program products for performing a boot sequence in a multi-processor system.

2. Description of Related Art

To increase the speed and performance of a computing system, a computer manufacturer may include multiple processors to divide up the processing duties of the system. However, increasing the number of processors in a system may increase the time to complete the loading of BIOS and an operating system. This increased delay is often the result of the system waiting for all of the processors and memory to complete initialization. Improving the initialization and booting sequence of a system may improve overall performance of a system and thus consumer satisfaction.

### SUMMARY OF THE INVENTION

Methods, apparatuses, and computer program products for performing a boot sequence in a multi-processor system are provided. Embodiments include: in response to detecting initiation of a boot sequence of the multi-processor system, initializing, by a bootstrap processor (BSP), BSP memory associated with the BSP and initializing, by an application processor, memory associated with the application processor; determining, by the BSP, whether the initialization of the BSP memory is completed; and if the initialization of the BSP memory is completed, loading, by the BSP, an operating system on the BSP memory regardless of whether the application processor has completed initialization of the memory associated with the application processor.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in performing a boot sequence in a multi-processor system according to embodiments of the present invention.

FIG. 2 sets forth a flow chart illustrating an exemplary method for performing a boot sequence in a multi-processor system according to embodiments of the present invention.

FIG. 3 sets forth a flow chart illustrating a further exemplary method for performing a boot sequence in a multi-processor system according to embodiments of the present invention.

### DETAILED DESCRIPTION OF EXEMPLARY EMBODIMENTS

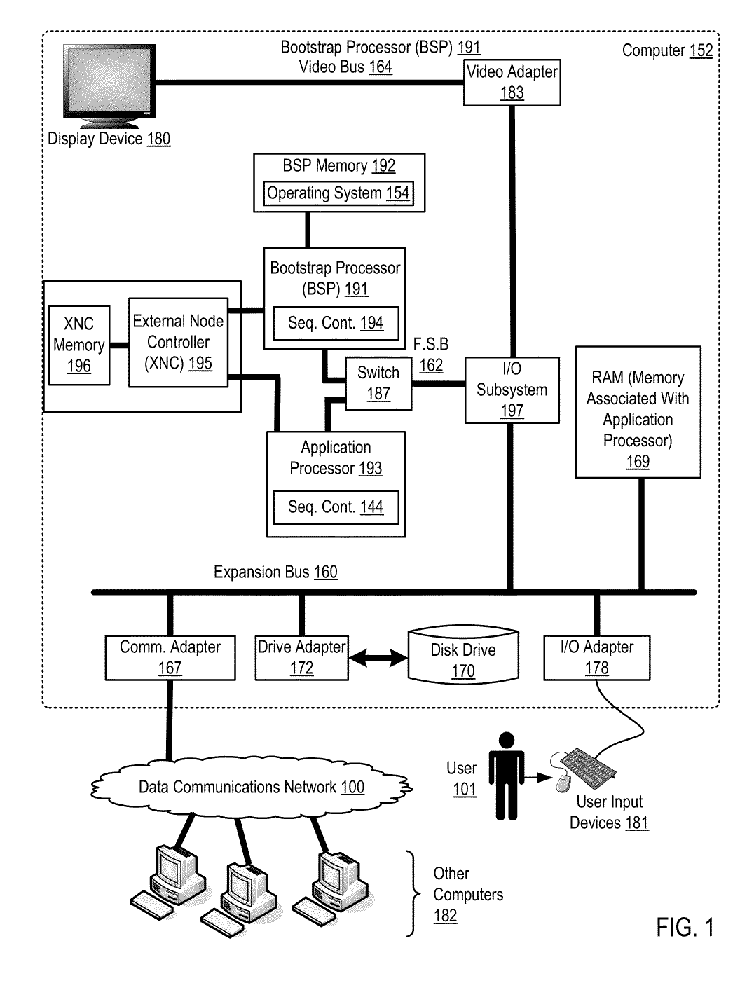

Exemplary methods, apparatus, and products for performing a boot sequence in a multi-processor system in accordance with the present invention are described with reference to the accompanying drawings, beginning with FIG. 1. Performing a boot sequence in a multi-processor system in accordance with the present invention is generally implemented with computers, that is, with automated computing machinery. FIG. 1 sets forth a block diagram of automated computing machinery comprising an exemplary computer (152) useful in performing a boot sequence in a multi-processor system according to embodiments of the present invention. The computer (152) is a multi-processor system that includes a bootstrap processor (BSP) (191) and an application processor (193). A BSP is a processor that performs the bootstrapping operations every time the computer (152) is power on. An application processor is a processor that executes other non-bootstrapping operations of the computer (152). Although one only application processor is illustrated in FIG. 1, performing a boot sequence according to embodiments of the present invention, may be performed in multi-processor systems with any number of application processors.

The computer (152) of FIG. 1 also includes a switch (187) that is coupled to the two processors (191, 193). The switch (187) of FIG. 1 is also coupled to an input/output (I/O) subsystem (197) and a front side bus (162). The switch (187) is configured to control bus connections between the processors (191 and 193) and the front side bus (162) and the I/O subsystem (197). Connections to the front side bus (162) enable a particular processor to access other components of the computer (152). For example, the application processor (193) is able to access random access memory (RAM) (169) associated with the application processor (193).

Coupled to the BSP (191) is dedicated BSP memory (192) that may be used by the BSP during a bootstrapping operation, such as loading BIOS or an operating system. For example, the BSP (191) may load an operating system (154) into the BSP (192). Operating systems useful performing a boot sequence in a multi-processor system according to embodiments of the present invention include UNIX™, Linux™, Microsoft XP™, AIX™, IBM's i5/OS™, and others as will occur to those of skill in the art. The operating system (154) in the example of FIG. 1 is shown in BSP (192), but many components of such software typically are stored in non-volatile memory also, such as, for example, on a disk drive (170).

In the example of FIG. 1, the application processor (193) includes an application processor sequence controller (144) that is used by the application processor (193) to perform a boot sequence according to embodiments of the present invention. Specifically, the application processor (193) includes computer program instructions that when executed by the application processor (193) cause the application processor (193) to initialize memory (169) associated with the application processor (193) in response to detecting initiation of a boot sequence of the multi-processor system.

In the example of FIG. 1, the BSP (191) includes a BSP sequence controller (194) that is used by the BSP (191) to perform a boot sequence according to embodiments of the present invention. Specifically, the BSP sequence controller (194) includes computer program instructions that when executed by the BSP (191) cause the BSP (191) to carry out the steps of: initialize BSP memory (192) associated with the BSP (191) in response to detecting initiation of a boot sequence of the multi-processor system; and determine whether the initialization of the BSP memory (192) is completed; and if the initialization of the BSP memory (192) is completed, load the operating system (154) in the BSP memory (192) regardless of whether the application processor (193) has completed initialization of the memory (169) associated with the application processor (193). By loading the operating system without waiting for the application processor (193) to initialize the memory associated with the application processor (193), the time to load the operating system may be reduced, thus improving overall system performance.

The server (152) also includes an external node controller (XNC) (195) coupled with dedicated XNC memory (196). An XNC is a hardware controller dedicated to coordinating communication between the processors of one node with the processors of another node, enabling multi-node processing. The XNC (195) is directly coupled to each processor (191, 193) and to an expansion bus (160) for connecting with other computers (182) via a data communications network (100).

The computer (152) of FIG. 1 includes disk drive adapter (172) coupled through the expansion bus (160) and I/O subsystem (197) and other components of the computer (152). Disk drive adapter (172) connects non-volatile data storage to the computer (152) in the form of disk drive (170). Disk drive adapters useful in computers for performing a boot sequence in a multi-processor system according to embodiments of the present invention include Integrated Drive Electronics (‘IDE’) adapters, Small Computer System Interface (‘SCSI’) adapters, and others as will occur to those of skill in the art. Non-volatile computer memory also may be implemented as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (183), which is an example of an I/O adapter specially designed for graphic output to a display device (180) such as a display screen or computer monitor. Video adapter (183) is connected to processor (156) through a high speed video bus (164), I/O subsystem (197), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for performing a boot sequence in a multi-processor system according to embodiments of the present invention include modems for wired dial-up communications, Ethernet (IEEE 802.3) adapters for wired data communications network communications, and 802.11 adapters for wireless data communications network communications.

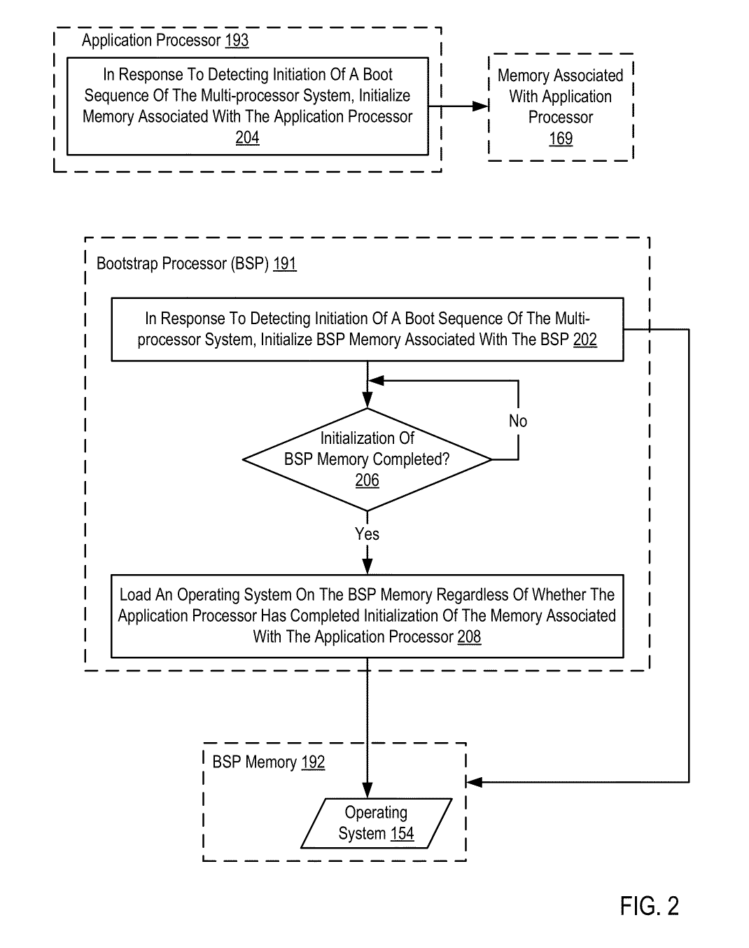

For further explanation, FIG. 2 sets forth a flow chart illustrating an exemplary method for performing a boot sequence in a multi-processor system according to embodiments of the present invention. The method of FIG. 2 includes initializing (202), by a bootstrap processor (BSP) (191), BSP memory (192) associated with the BSP (191) in response to detecting initiation of a boot sequence of the multi-processor system (152). A boot sequence may be initiated when the computer (152) is turned ‘on.’ The boot sequence may include the BSP (191) performing a power-on self-test (POST). Instructions for the POST may be stored in BIOS or may be stored on a physical storage device (e.g., a hard disk drive) with the address for the POST stored in the BIOS. Typically, the POST sends information to each computer component associated with the computer (152) to ensure each associate computer device is functioning properly. For example, the POST may send out a signal on a bus to determine which input/output devices, such as keyboard, monitor, mouse or other I/O devices are attached to the computer (152). As part of the boot sequence, the BSP (191) may initialize the BSP memory (192). Initializing (202) BSP memory (192) may be carried out by supplying power to the BSP memory (192); verifying connection continuity within the BSP memory (192); verifying program operation or functionality within the BSP memory (192); providing a command or sequence of commands or other instructions to the BSP memory (192); and or other suitable operations as would occur to one of skill in the art.

The method of FIG. 2 also includes initializing (204), by an application processor (193), memory (169) associated with the application processor (193). Initializing (204), by an application processor (193), memory (169) associated with the application processor (193) may be carried out by supplying power to the memory (169); verifying connection continuity; verifying program operation or functionality; providing a command or sequence of commands, or other instructions to the memory (169) and or other suitable operations as would occur to one of skill in the art.

The method of FIG. 2 also includes determining (206), by the BSP (191), whether the initialization of the BSP memory (192) is completed. Determining (206), by the BSP (191), whether the initialization of the BSP memory (192) is completed may be carried out by receiving an indication from the BSP memory that the BSP memory has been initialized.

If the initialization of the BSP memory is completed, the method of FIG. 2 includes loading (208), by the BSP (191), an operating system (154) on the BSP memory (192) regardless of whether the application processor (193) has completed initialization of the memory (169) associated with the application processor (193). Loading, or booting up, the operating system is different than installing the operating system. Installing the operating system is generally the process of storing or writing the instructions onto the hard disk to initially install the program in computer system. Loading generally refers to accessing or copying the installed instructions to a location in memory, such as the BSP memory (192) whereby the BSP processor (191) may readily access the instructions. Generally, when loading the operating system, the BIOS boot up process first copies the initial system files. The initial system file is used to load the remaining instructions of the operating system such as the system files and the system configuration file. These files allow BIOS to interact with the computer system while running and provide specific information on certain applications or programs that may need a device driver to operate with the computer system. In addition to loading the operating system, subsets of certain applications may also be loaded. The subset of certain applications generally includes an application program interface, which allows the operating system to communicate and interact with the application. Examples of applications that may be loaded include word processors, database programs, and any other suitable programs. Loading (208), by the BSP (191), an operating system (154) in the BSP memory (192) regardless of whether the application processor (193) has completed initialization of the memory (169) associated with the application processor (193) may be carried out by copying the operating system into the BSP memory (192).

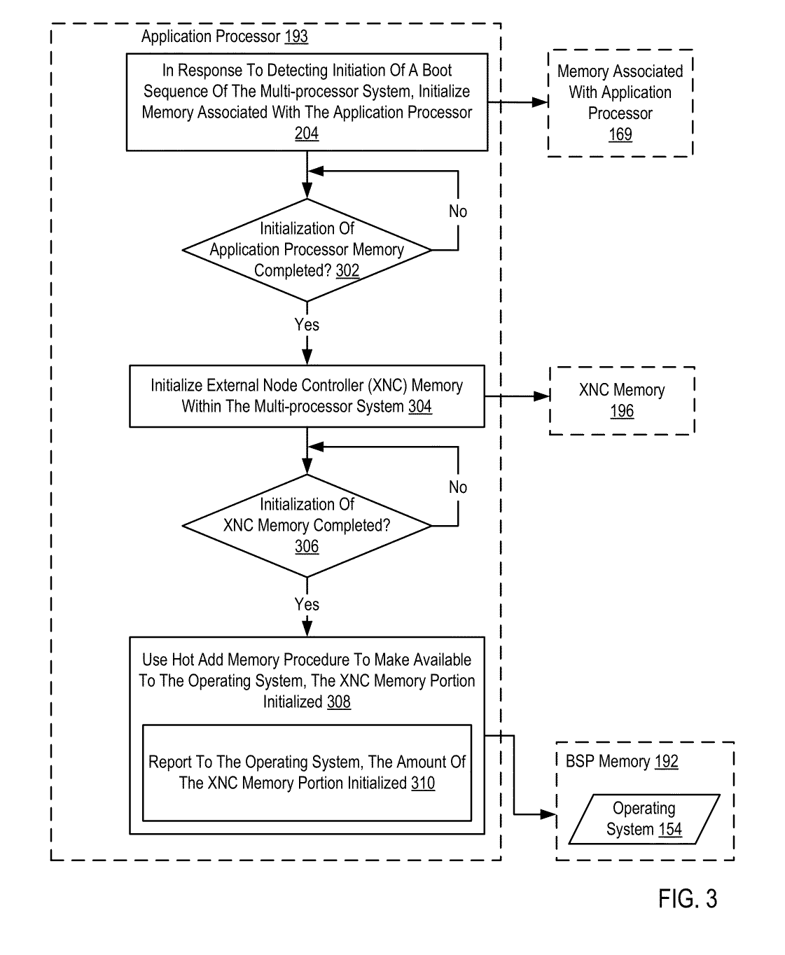

For further explanation, FIG. 3 sets forth a flow chart illustrating a further exemplary method for performing a boot sequence in a multi-processor system according to embodiments of the present invention. The method of FIG. 3 is similar to the method of FIG. 2 in that the method of FIG. 3 also includes initializing (204), by an application processor (193), memory (169) associated with the application processor (193).

The method of FIG. 3 also includes determining (302), by the application processor (193), whether the initialization of the memory (169) associated with the application processor (193) is completed. Determining (302), by the application processor (193), whether the initialization of the memory (169) associated with the application processor (193) is completed may be carried out by receiving an indication from the memory (169) that the memory (169) has been initialized.

If the initialization of the memory associated with the application processor is completed, the method of FIG. 3 includes initializing (304), by the application processor (193), at least a portion of external node controller (XNC) memory (196) within the multi-processor system (152). Initializing (304) at least a portion of XNC memory (196) within the multi-processor system (152) may be carried out by supplying power to the XNC memory (196); verifying connection continuity within the XNC memory (196); verifying program operation or functionality within the XNC memory (196); providing a command or sequence of commands, or other instructions to the XNC memory (196) and or other suitable operations as would occur to one of skill in the art. Initialization of the XNC memory 9196) may be performed by one or more application processors. For example, a first application processor may initialize a first half of the XNC memory and a second application processor may initialize a second half of the XNC memory.

The method of FIG. 3 also includes determining (306), by the application processor (193), whether the initialization of the XNC memory (196) is completed. Determining (306) whether the initialization of the XNC memory (196) is completed may be carried out by receiving an indication from the XNC memory (196) that the XNC memory (196) has been initialized.

If the initialization of the XNC memory is completed, the method of FIG. 3 includes using (308) a hot add memory procedure to make available to the operating system (154), the XNC memory portion initialized. A hot add memory procedure is execution of a series of instructions that enables additional memory resources to be added to the operating system memory pool while the computer running the operating system is turned on. The hot add memory procedure may also include adding to the pool of memory resources of the operating system (154), the memory (169) associated with the application processor (193). Using (308) a hot add memory procedure to make available to the operating system (154), the XNC memory portion initialized may be carried out by instructing the operating system to perform the hot add memory procedure.

In the example of FIG. 3, using (308) a hot add memory procedure to make available to the operating system (154) the XNC memory portion initialized includes reporting (310) to the operating system (154), by the application processor (193), the amount of the XNC memory portion initialized. Reporting (310) to the operating system (154), by the application processor (193), the amount of the XNC memory portion initialized may be carried out by transmitting a message to the operating system indicating the amount of the XNC memory portion that was initialized. By loading the operating system without waiting for the application processor (193) to initialize the XNC memory (196), the time to load the operating system may be reduced, thus improving overall system performance.

Exemplary embodiments of the present invention are described largely in the context of a fully functional computer system for performing a boot sequence in a multi-processor system. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for performing a boot sequence in a multi-processor system, the method comprising:
in response to detecting initiation of a boot sequence of the multi-processor system, initializing, by a bootstrap processor (BSP), BSP memory associated with the BSP and initializing, by an application processor, memory associated with the application processor;
determining, by the BSP, whether the initialization of the BSP memory is completed; and
if the initialization of the BSP memory is completed, loading, by the BSP, an operating system on the BSP memory regardless of whether the application processor has completed initialization of the memory associated with the application processor.

2. The method of claim 1 further comprising:
determining, by the application processor, whether the initialization of the memory associated with the application processor is completed; and
if the initialization of the memory associated with the application processor is completed, initializing, by the application processor, at least a portion of external node controller (XNC) memory within the multi-processor system.

3. The method of claim 2 wherein the XNC memory portion is initialized without the use of system management interrupts (SMI).

4. The method of claim 2 further comprising:
determining, by the application processor, whether the initialization of the XNC memory is completed; and
if the initialization of the XNC memory is completed, using a hot add memory procedure to make available to the operating system, the XNC memory portion initialized.

5. The method of claim 4 wherein using a hot add memory procedure to make available to the operating system, the XNC memory portion initialized includes reporting to the operating system, by the application processor, the amount of the XNC memory portion initialized.

6. The method of claim 1 wherein the initialization of the memory associated with the application processor and the initialization of the XNC memory portion are performed during loading of the operating system.

7. An apparatus for performing a boot sequence in a multi-processor system, the apparatus comprising a computer processor, a computer memory operatively coupled to the computer processor, the computer memory having disposed within it computer program instructions that when executed by the computer processor cause the computer processor to carry out the steps of:
in response to detecting initiation of a boot sequence of the multi-processor system, initializing, by a bootstrap processor (BSP), BSP memory associated with the BSP and initializing, by an application processor, memory associated with the application processor;
determining, by the BSP, whether the initialization of the BSP memory is completed; and
if the initialization of the BSP memory is completed, loading, by the BSP, an operating system on the BSP memory regardless of whether the application processor has completed initialization of the memory associated with the application processor.

8. The apparatus of claim 7 further comprising computer program instructions that when executed by the computer processor cause the computer processor to carry out the steps of:
determining, by the application processor, whether the initialization of the memory associated with the application processor is completed; and
if the initialization of the memory associated with the application processor is completed, initializing, by the application processor, at least a portion of external node controller (XNC) memory within the multi-processor system.

9. The apparatus of claim 8 wherein the XNC memory portion is initialized without the use of system management interrupts (SMI).

10. The apparatus of claim 8 further comprising computer program instructions that when executed by the computer processor cause the computer processor to carry out the steps of:
determining, by the application processor, whether the initialization of the XNC memory is completed; and
if the initialization of the XNC memory is completed, using a hot add memory procedure to make available to the operating system, the XNC memory portion initialized.

11. The apparatus of claim 10 wherein using a hot add memory procedure to make available to the operating system, the XNC memory portion initialized includes reporting to the operating system, by the application processor, the amount of the XNC memory portion initialized.

12. The apparatus of claim 7 wherein the initialization of the memory associated with the application processor and the initialization of the XNC memory portion are performed during loading of the operating system.

13. A computer program product for performing a boot sequence in a multi-processor system, the computer program product disposed upon a computer readable medium, the computer program product comprising computer program instructions capable, when executed, of causing a computer to carry out the steps of:
in response to detecting initiation of a boot sequence of the multi-processor system, initializing, by a bootstrap processor (BSP), BSP memory associated with the BSP and initializing, by an application processor, memory associated with the application processor;
determining, by the BSP, whether the initialization of the BSP memory is completed; and
if the initialization of the BSP memory is completed, loading, by the BSP, an operating system on the BSP memory regardless of whether the application processor has completed initialization of the memory associated with the application processor.

14. The computer program product of claim 13 further comprising computer program instructions capable, when executed, of causing a computer to carry out the steps of:
determining, by the application processor, whether the initialization of the memory associated with the application processor is completed; and
if the initialization of the memory associated with the application processor is completed, initializing, by the application processor, at least a portion of external node controller (XNC) memory within the multi-processor system.

15. The computer program product of claim 14 wherein the XNC memory portion is initialized without the use of system management interrupts (SMI).

16. The computer program product of claim 14 further comprising computer program instructions capable, when executed, of causing a computer to carry out the steps of:
determining, by the application processor, whether the initialization of the XNC memory is completed; and
if the initialization of the XNC memory is completed, using a hot add memory procedure to make available to the operating system, the XNC memory portion initialized.

17. The computer program product of claim 16 wherein using a hot add memory procedure to make available to the operating system, the XNC memory portion initialized includes reporting to the operating system, by the application processor, the amount of the XNC memory portion initialized.

18. The computer program product of claim 13 wherein the initialization of the memory associated with the application processor and the initialization of the XNC memory portion are performed during loading of the operating system.

19. The computer program product of claim 13, wherein the computer readable medium further comprises a computer readable signal medium.

20. The computer program product of claim 13, wherein the computer readable medium further comprises a computer readable storage medium.
